(19) United States
(12) Patent Application Publication
(10) Pub. No.: US 2023/0098472 A1
(43) Pub. Date: Mar. 30, 2023

(54) FACE MASK WITH FILTERED COOLING AIR SUPPLY

(71) Applicant: Endliss Technology, Inc., Hayward, CA (US)

(72) Inventors: Sen Cai, Hayward, CA (US); Weiguang Huang, Pleasanton, CA (US)

(21) Appl. No.: 17/936,050

(22) Filed: Sep. 28, 2022

Related U.S. Application Data
(60) Provisional application No. 63/261,758, filed on Sep. 28, 2021.

(51) Int. Cl. A62B 9/00; A62B 7/10; A62B 18/02; F25B 21/02

(52) U.S. Cl. CPC A62B 9/003; A62B 7/10; A62B 18/025; F25B 21/02

(57) ABSTRACT

A cooling purified air breathing system for use during activity or in warm environments. The system includes a wearable portable air purifier having an opening for discharging cooling air, and a face mask configured to cover at least a user's nose and mouth. Air tubing is used to direct cooling filtered air into the mask, either through an opening or via a clip and connector attached to an edge of the mask. The air purifier is preferably worn in close proximity to the mask, such as around the back of the neck of the user.

### RELATED APPLICATION

The present application claims the filing priority of U.S. Provisional Application No. 63/261,758, titled “FACE MASK WITH FILTERED AIR SUPPLY,” and filed on Sep. 28, 2021. The '758 application is hereby incorporated by reference.

### TECHNICAL FIELD OF THE INVENTION

The present invention relates to air-filtering breathing masks. More specifically, the invention relates to personal air-conditioned breathing masks.

### BACKGROUND OF THE INVENTION

The need for quality breathing masks has probably never been more important in U.S. history than it is now, going back to early 2020. The concern over spreading contagious viruses and other airborne pathogens during respiration has led many Americans to travel, shop, work, and even exercise donning masks or other forms of face (predominately mouth and nose) coverings. According to a Denver report, the global sale of face masks went from a mere $800 million in 2019 to more than $165 billion in 2020. Projections for 2021 are even higher. However, the greatest innovation in these ubiquitous articles during that same time period has come mostly in the form of style, e.g., colors, slogans, images, designs, etc., with very little improvements made in the way of function.

While mask-wearing for some has become a fashion statement of sorts, there is still a desire by others to be protected during all activities, indoor as well as outdoor. Adding to the problem of breathing through a filtering material is the build-up of heat that may occur during certain activities. This can lead to anxiousness in the mask-wearer, causing an increased breathing rate and further heat build-up.

Accordingly, a mask is needed which both protects a user from inhaling foreign matter, such as viruses, pollutants, allergens, and the like, and provides a cooling air flow to help maintain user comfort. Until the invention of the present application, these and other problems in the prior art went either unnoticed or unsolved by those skilled in the art. The present invention provides a personal mask which perform multiple functions without sacrificing comfort, design, style, or affordability.

### SUMMARY OF THE INVENTION

There is disclosed herein an improved air breathing system which avoids the disadvantages of prior devices while affording additional structural and operating advantages.

Generally speaking, the air breathing system comprises a face mask, a portable air purifying device, and air tubing to connector the purifying device to the mask. The mask is preferably configured to cover at least a user's nose and mouth, and the portable air purifier is preferably configured to be positioned to rest on a user's shoulders and partially wrap around the neck area. The purifier includes an opening for discharging cool air through the tubing and into the mask.

In embodiments an opening through the mask may be used for directing the discharging cooling air into the face mask. Alternatively, a clip may be used to direct the discharging cooling air around an edge of the face mask.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a backside view of a first embodiment of the disclosed air purifying mask;

FIG. 2 is a front view of the embodiment of FIG. 1;

FIG. 3 is a top view of the embodiment of FIG. 1;

FIG. 4 is a bottom view of the embodiment of FIG. 1;

FIG. 5 is a left-side view of the embodiment of FIG. 1;

FIG. 6 is a right-side view of the embodiment of FIG. 1;

FIG. 7 is a backside view of a second embodiment of the disclosed air purifying mask;

FIG. 8 is a front view of the embodiment of FIG. 7;

FIG. 9 is a top view of the embodiment of FIG. 7;

FIG. 10 is a bottom view of the embodiment of FIG. 7;

FIG. 11 is a left-side view of the embodiment of FIG. 7;

FIG. 12 is a right-side view of the embodiment of FIG. 7;

FIG. 13A is a side view of an embodiment of the disclosed air purifying device;

FIG. 13B is a close-up view of the intake vent and components;

FIG. 14 is a bottom view of the air purifying device of FIG. 13A;

FIG. 15 is another side view of the air purifying device of FIG. 13A;

FIG. 16 is a top view of an embodiment of the disclosed cooling air breathing system; and

FIG. 17 shows a prior art air filtering system using a filtering device attached to a user's arm.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

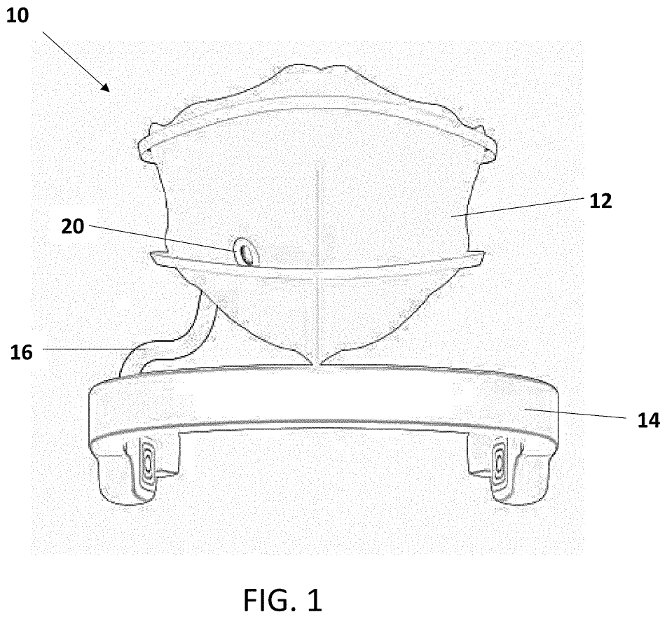

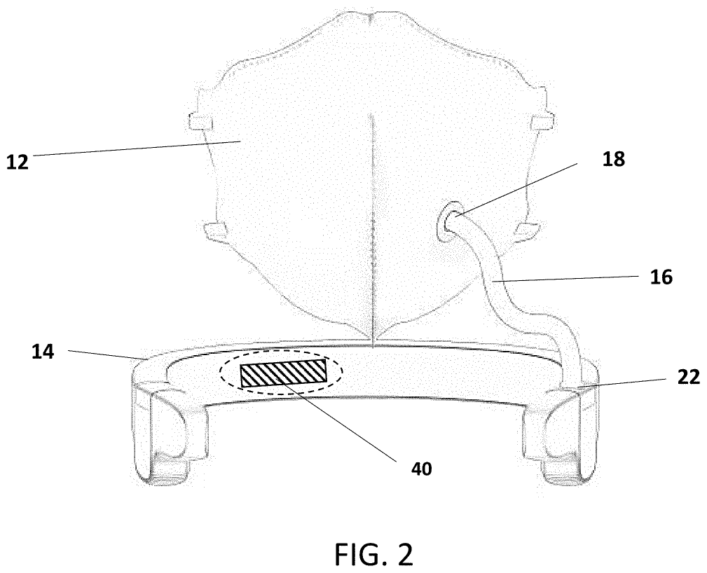

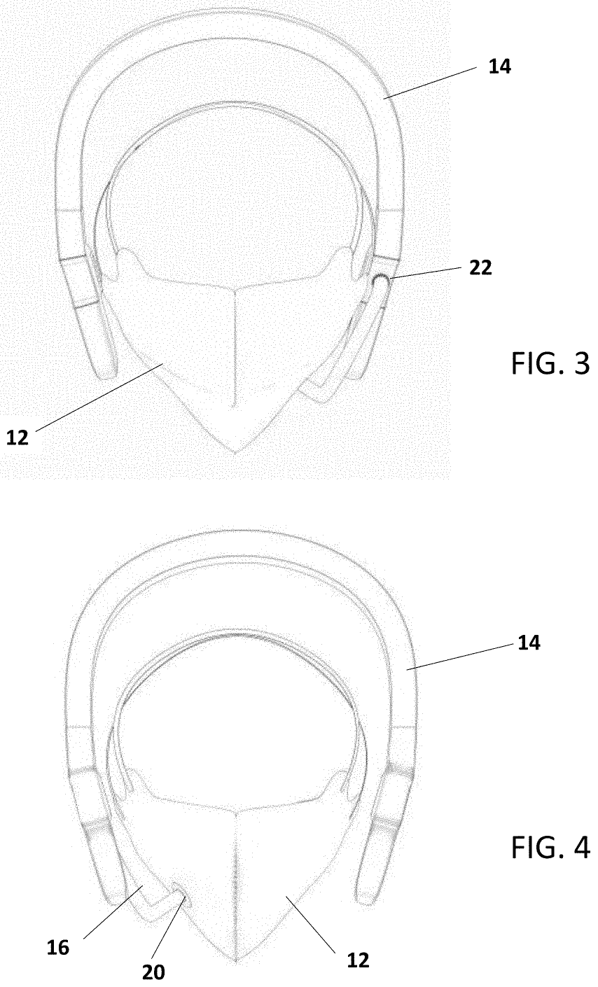

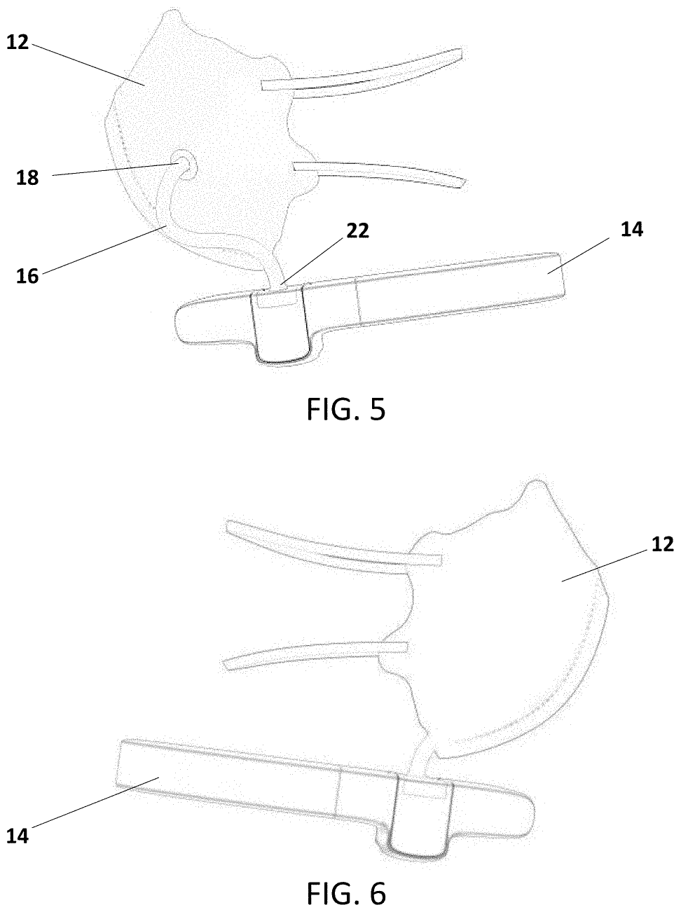

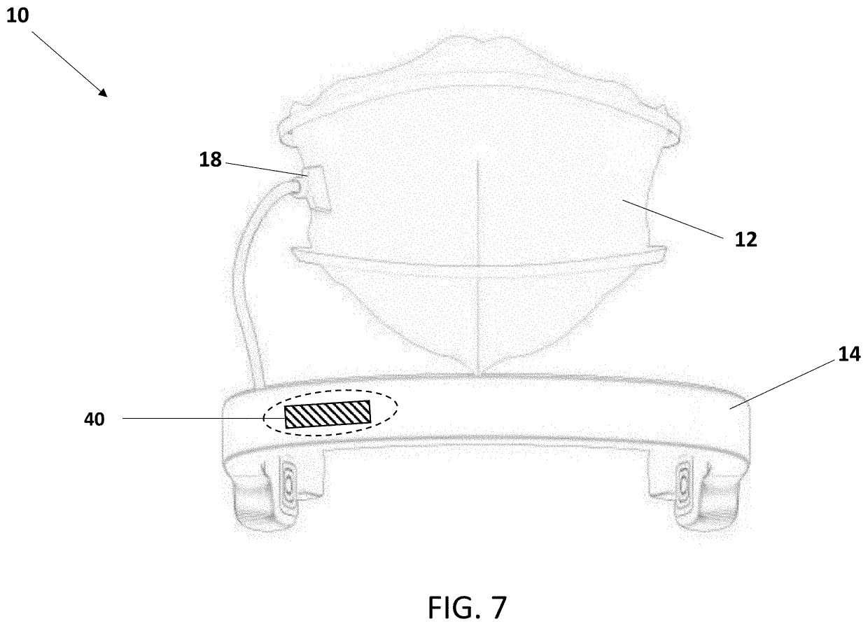

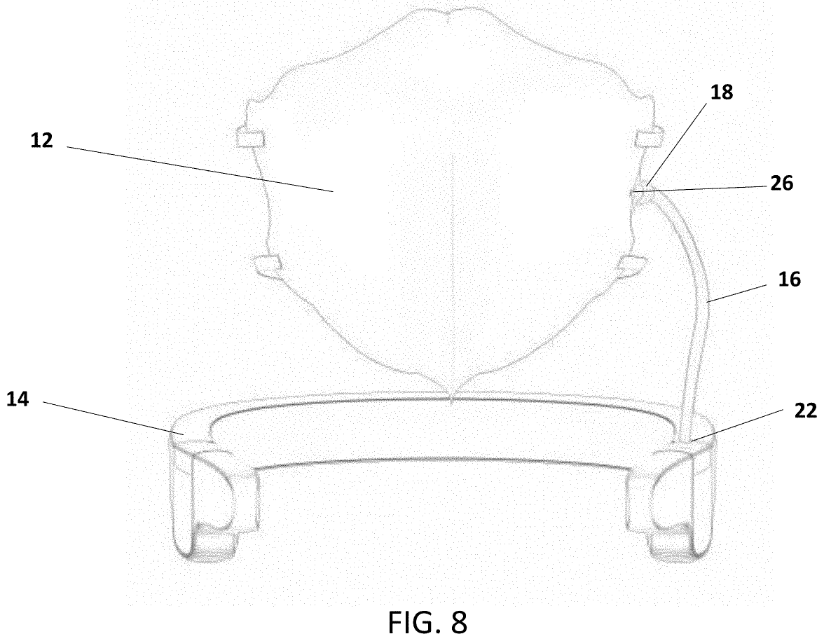

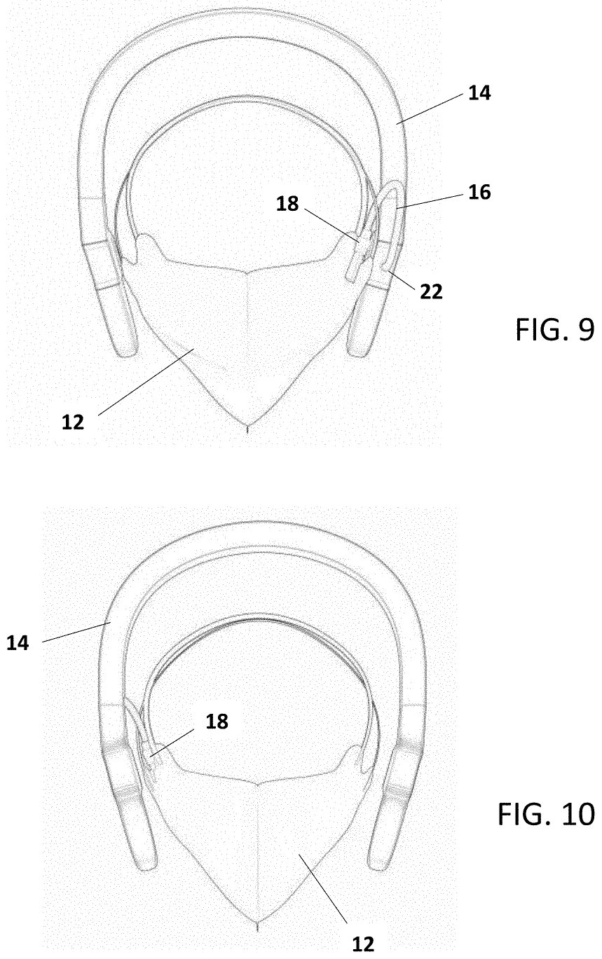

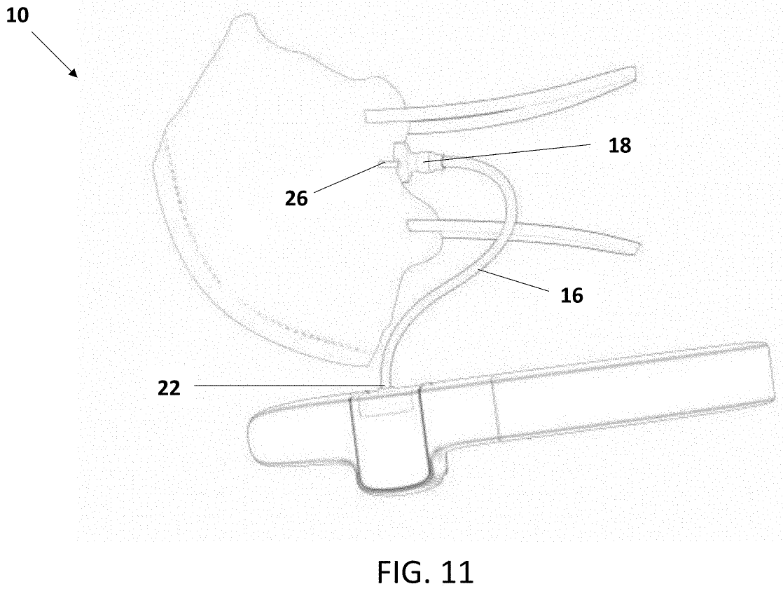

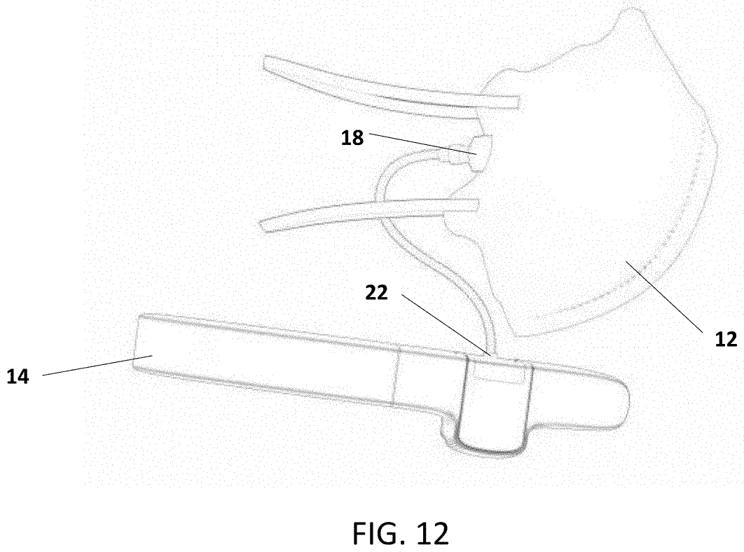

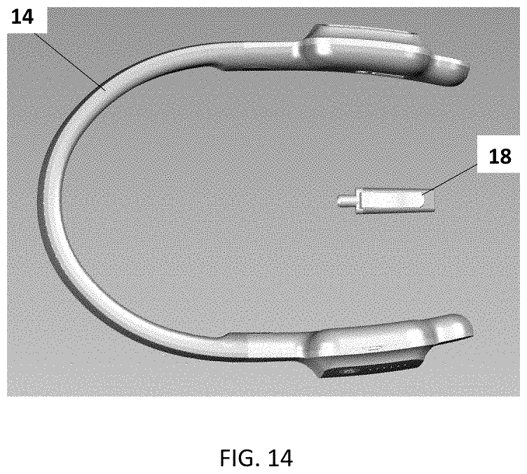

Referring to FIGS. 1-16, multiple embodiments of the disclosed air purifying mask system, generally indicated by the reference numeral 10, are shown. The system 10 is generally comprised of a mask 12, which preferably covers at least the nose and mouth of a user when properly worn, an air purifying device 14, air tubing 16, and an output connector 18, which connects the tubing 16 to the mask 12 and discharges cooling air into the mask. Once connected and turned on, the purifying device 14 will deliver cooling air into the face mask 12 for the user to breath. By “into the mask” it is meant that cooling air is delivered to the side of the mask which is worn against the face of the user (i.e., inside the mask). The delivery of the purified cooling air is shown to go through the front of the mask 12 via an opening/port 20 (FIGS. 1-6) or around a side of the mask 12 via a clip 26 attached to the output connector 18 (FIGS. 7-12). Also, the terms “cooling,” “cooled,” and “cool” air are intended to reference air having a cooling effect by displacing warmer, stagnant air trapped between the mask 12 and a user's face. The cooling air may be cooler than ambient air by virtue of being purified and drier than ambient air.

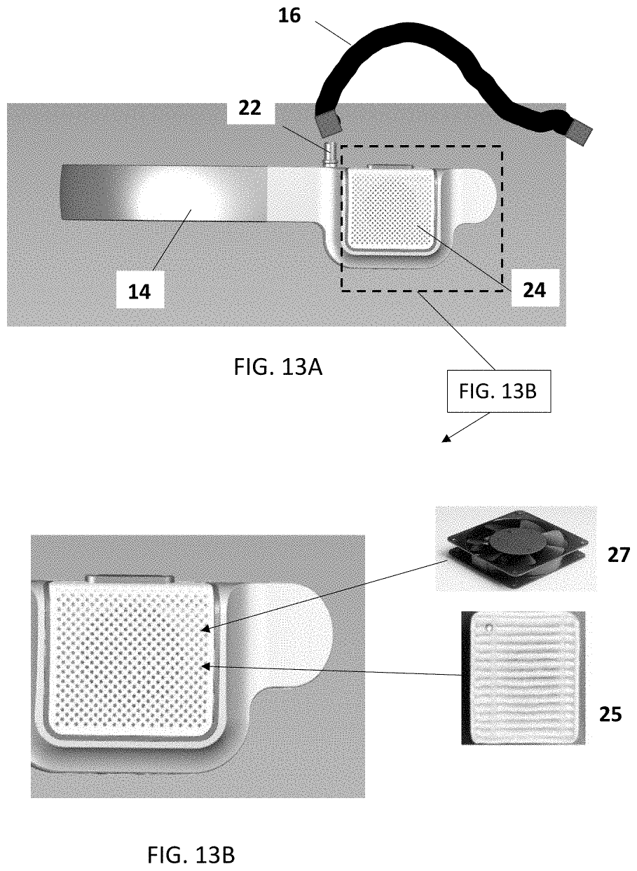

In the embodiment of FIGS. 1-6, cooling air is piped to and through the front surface of the mask 12 via opening/port 20. The cooling air is created in device 14 by drawing in ambient air through vent opening 24 via a small electric fan 25 (see FIG. 13B), filtering the ambient air via a filter cartridge 27 (or optionally creating cooler air via a Peltier module 40), and discharging the cooling air through the air output connector 18. The cooling air is piped via tubing 16 from the device 14 to the mask 12. The output connector 18 connects to an end of the tubing 16 and to the opening/port 20 to direct the cooling air into a front face of the mask 12.

In the embodiment of FIGS. 7-12, the configuration is much the same as the previous embodiment. The key distinction is that cooling air is piped, via tubing 16, to the backside of the mask 12 using a different output connector 18. That is, a clip on the output connector 18 allows the tubing 16 to discharge the cooling air directly to the backside of the mask 12 rather than passing through an opening on the mask 12 from the front side. This embodiment allows the system 10 to be retrofit to most any type of face covering, including gaiters, scarves, bandanas, and the like.

As for the purifying device 14, similar devices are well-known in the art. Such a device is generically known as a thermoelectric cooler but is commercially available and may be advertised as a “portable air conditioner” or a “personal air conditioner.” Some of these devices filter air while others operate using a Peltier module, which is a device comprised of two joined conductors to form a cooling plate when voltage is applied across the junction to create current. This results in a low temperature on one of the conductors, and at least one fan is used to pull air into a cooling chamber and across the cooling plate, before pushing the cooled air out an air output port 22.

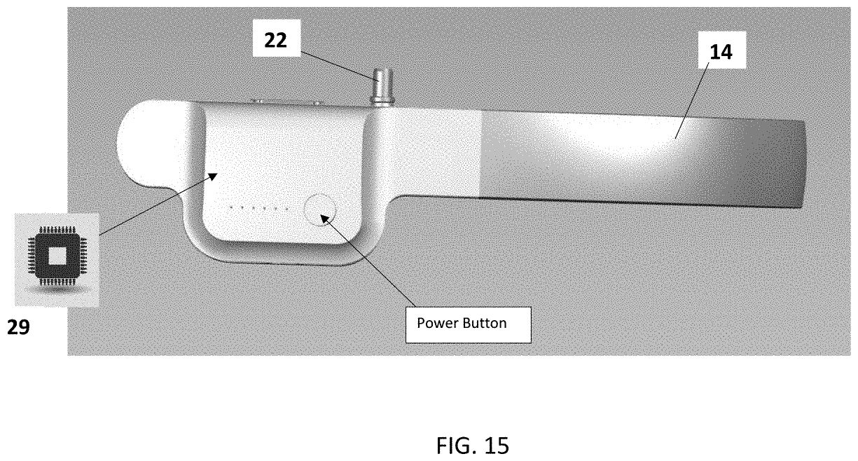

Referring to FIGS. 13-16, there is illustrated the basic components of an embodiment of a cool air breathing system 10. The system comprises a mask 12, purifying unit 14 having a small electric fan 25 and a removable filter cartridge 27, an air tube 16, and output connector 18. A battery, control board 29 and power switch are shown on an opposite side of the filter 27 in FIG. 15. The particular illustrated system 10 is for positioning the cooling/purified air device 14 about a user's shoulder and neck area (see U.S. Pat. No. 10,578,119 to Lee, the entirety of which is hereby incorporated by reference), while the mask 12 is placed over the user's nose and mouth. However, it should be understood that the principles of the invention can be more broadly applied to a system that is positioned almost anywhere on a user. For example, the purifying air device 14 may be attached around a user's head, contained within a pocket, hung from the torso, strapped to the waist, and the like, as long as the unit 14 is portable and maintained with the user.

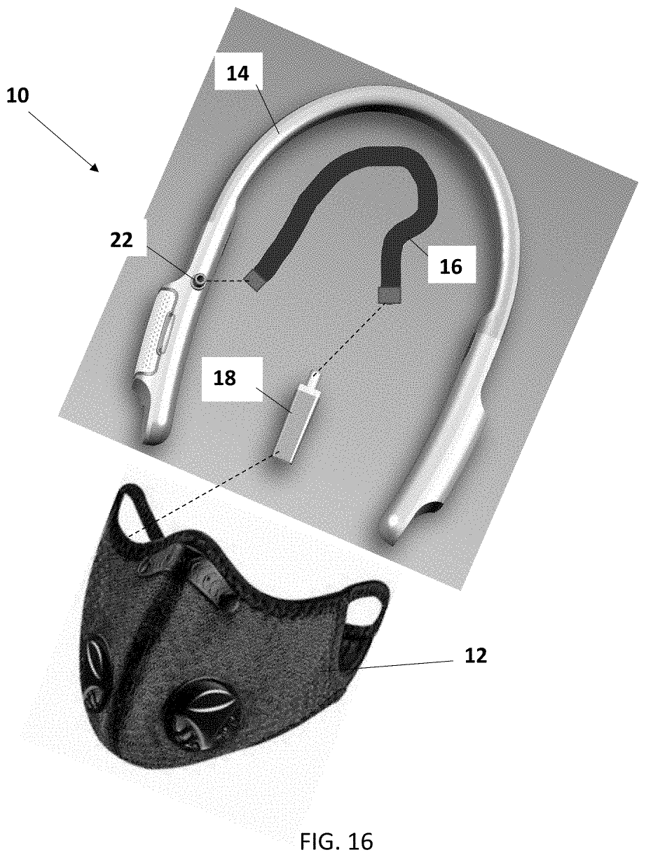

As can be seen in FIG. 16, the purifying air device 14 comprises a curved body 30 to allow comfortable positioning about a user's neck. The device 14 has at least one vent or opening where cooling air is discharged. In the illustrated embodiment, the cooling air is delivered into the mask 12 via air tubing 16.

The tubing 16 is preferably comprised of a flexible plastic or rubber material but may be a more rigid plastic or light metal material in specific applications. The mask 12, of course, may be most any type of personal face mask configured to cover a user's nose and mouth, such as N95 and KN95 masks but also including neck gaiters, scarves, bandanas, and the like. Typically, the mask 12 is secured to the user's face with two ear loops, though other securing means may be used. These masks come in a variety of sizes, styles, colors, and may be either vented or unvented.

FIG. 16 illustrates an embodiment of the present invention. As can be seen, the mask component completely covers the user's mouth and nose, but also encloses an opening or discharge port 22 of the purifying air device 14 to direct cooling air, via tubing 16, into the breathing mask 12. In alternate embodiments, the mask 12 may have an extended portion which allows covering of the discharge port/opening 22, or an integral channel or duct may be used to direct flow into the mask 12.

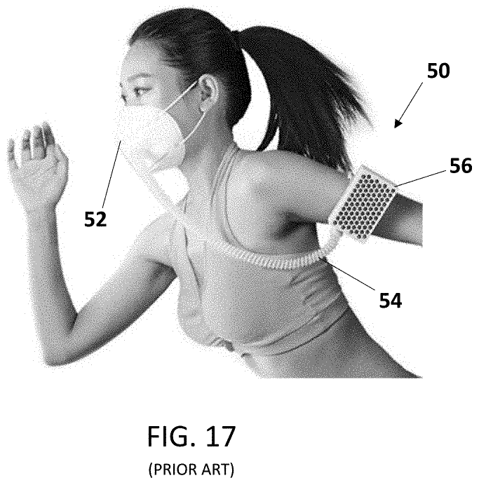

FIG. 17 illustrates a prior art system 50 wherein a mask 52 is connected via tubing 54 to a filtering device 56 attached to a user's arm. The device 50 does not provide cooling air to the user, as there is no fan to drive the flow of air to the mask 52. In use, air is drawn into the filter 56 via a slight vacuum created by the user's breathing within the mask 52. In this device 50, ambient air is pulled into the filter 56, through tubing 54, and into the mask 52.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An air breathing system comprising:
a face covering configured to cover at least a user's nose and mouth;
a portable air purifying device comprising:
an air intake port;
an air filtering module; and
an air output port,
wherein during operation of the portable air purifying device, ambient air is pulled into the air intake port, filtered within the air filtering module to create cooling purified air, and the cooling purified air is discharged from the output port;
a length of air tubing connected by a first end to the air output port of the portable air purifying device and by a second end to the face mask;
wherein the second end of the air tubing is configured to direct the discharged cooling air into the face mask.

2. The air breathing system of claim 1, wherein the portable air purifying device comprises a Peltier module.

3. The air breathing system of claim 1, wherein the portable air purifying device is configured to be positioned on a user's body.

4. The air breathing system of claim 3, wherein the portable air purifying device is configured to be positioned over a user's shoulders and about a neck area.

5. The air breathing system of claim 1, wherein the face mask includes a port to which the second end of the air tubing is attached.

6. The air breathing system of claim 1, wherein the air tubing is attached to an edge of the mask to direct cooling air into the mask.

7. The air breathing system of claim 6, further comprising a clip connector which attaches the second end of the air tubing to an edge of the mask.

8. The air breathing system of claim 1, wherein the air tubing conducts cooling air to a backside of the mask.

9. The air breathing system of claim 1, further comprising an electric fan to move air through the filtering module.

10. The air breathing system of claim 9, wherein the filtering module is removable.

11. An air breathing system comprising:
a wearable portable air purifying device comprising:
a body;
an electric fan;
an air intake port for taking ambient air into the body via the electric fan;
an air chamber within the body for filtering the ambient air; and
an air output port for discharging cooling air from the body;
tubing having a first end connected to the air output port and a second end for delivering discharged cooling air from the air output port; and
a face mask configured to cover a user's nose, mouth, and the second end of the tubing such that the cooling air discharging from the air output is delivered into the mask.

12. The air breathing system of claim 11, wherein the portable air purifying device comprises a curved body such that it can be positioned over a user's shoulders and about the neck area.

13. The air breathing system of claim 11, wherein the face mask includes a connector to which the second end of the tubing is attached.

14. The air breathing system of claim 11, further comprising a Peltier module for cooling the filtered air before being discharged to the face mask.
